(19) United States
(12) Patent Application Publication
(10) Pub. No.: US 2021/0062591 A1
(43) Pub. Date: Mar. 4, 2021

(54) A METHOD OF INSTALLING A REINFORCED THERMOPLASTIC PIPE (RTP)

(71) Applicant: PETROLIAM NASIONAL BERHAD (PETRONAS), Kuala Lumpur (MY)

(72) Inventors: Abdulla Bin Kasim, Kuala Lumpur (MY); Khairul Mustaqim Bin Abdul Zziz, Kuala Lumpur (MY); M Azriyuddin Bin Yaakub, Kuala Lumpur (MY); Syazrul Bin M Noor, Kuala Lumpur (MY); Hasrizal Bin A Rahman, Kuala Lumpur (MY)

(73) Assignee: Petroliam Nasional Berhad, Kuala Lumpur (MY)

(21) Appl. No.: 16/964,842

(22) PCT Filed: Jan. 28, 2019
(86) PCT No.: PCT/MY2019/050006

§ 371 Date: Jul. 24, 2020

(30) Foreign Application Priority Data
Jan. 26, 2018 (MY) PI2018000112

(51) Int. Cl. E21B 17/20; F16L 55/165

(52) U.S. Cl. CPC E21B 17/20; F16L 55/165

(57) ABSTRACT

A method of installing a reinforced thermoplastic pipe (RTP) (102) in a production tube is provided, the method includes the steps of preparing a bottom assembly (703) in a production well, swaging connectors (707, 709) onto both ends of the RTP (102),

and connecting respective ends of the RTP (102) with connectors (707, 709) to top and bottom assemblies (701, 703), characterized in that, the connectors (707, 709) further include metal collars that maintain shape of the RTP (102) and prevents pressure from escaping the RTP (102) and a blowout preventer (BOP) (116) is provided to cut off the RTP (102) when displacement is detected by the trip tank (118).

### FIELD OF INVENTION

The invention relates to a method of installing a reinforced thermoplastic pipe (RTP) in a production tube using a coiled tubing unit (CTU) thereof.

### BACKGROUND

Workover success rate of shut in wells is very low and expensive due to the prolonged periods necessary to retrieve existing pipes. Shut in wells are able to produce oil, but are not able to be fixed due to tubing leaking issues that cannot be plugged. This is because of the corrosion and erosion of existing tubing due to CO₂/H₂S contaminants, and sanding issues.

U.S. Pat. No. 6,978,843 describes a method of increasing production by inserting a tubing of smaller diameter into an existing production tubing. The document describes a method of installation of inserting the tube along the production tube and hanging the velocity string from the well head. However, the document does not provide any details on the method of installation. The flexibility of the RTP presents challenges during standard installation as pressure may escape from the RTP as the pipes are not as stiff as steel pipes.

Therefore, there is a need to provide a method for installing reinforced thermoplastic pipe in existing production tubing as an alternative to workover and remedying tubing leaking problem in order to successfully reinstate the idle well and resume production or injection.

### SUMMARY OF INVENTION

In an aspect of the invention there is provided a method of installing a reinforced thermoplastic pipe (RTP) in a production tube, the method includes the steps of:
preparing a bottom assembly in a production well,
swaging connectors onto both ends of the RTP,
connecting respective ends of the RTP with connectors to top and bottom assemblies, characterized in that, the connectors further include metal collars that maintain shape of the RTP and prevents pressure from escaping the RTP and a blowout preventer (BOP) is provided to cut off the RTP when displacement is detected by the trip tank.

In one embodiment, the RTP is run from a spool through a gooseneck to ensure that the RTP does not kink and bends properly.

In one embodiment, the method further includes displacing released liquids and/or gases overflowing from reservoir into a trip tank.

In one embodiment, the RTP is swaged vertically to a connector facing upwards and measured out to a predetermined length between a top packer setting length and a bottom packer setting length. The swaged end of the connector is connected to the bottom assembly into the CTU for a predetermined top packer setting depth.

Typically, a packer is used to hold the RTP in place inside existing tubing after being detached from CTU and to isolate leaks from being in contact with the RTP or flow area. Both ends of the RTP are then connected to a top assembly and bottom assembly respectively.

Advantageously, the method further includes securing the RTP and to minimize damage to the RTP by distributing the force over a larger surface during swaging process and make up to assembly.

In a further aspect, there is provided a coiled tubing unit (CTU) for installing a reinforced thermoplastic pipe (RTP) in a production tube, the unit includes:
an injector block supported by an injector head, used to direct the RTP with assembly into the production tube,
characterized in that, both ends of the RTP fits the connectors with a metal collar,
wherein the metal collar maintains shape of the RTP and prevents pressure from escaping the RTP and a trip tank is further connected to the CTU for displacing released liquids and/or gases overflowing from reservoir into the trip tank.

In an embodiment, the CTU includes a gooseneck on top of the CTU, which is to ensure that the RTP does not kink and would bend correctly into the assembly.

Advantageously, a rod clamp is provided for securing the RTP and to minimize damage to the RTP by distributing the force over a larger surface during swaging process and make up to assembly.

In one embodiment, a trip tank is further connected to the CTU for advantageously displacing released liquids and/or gases overflowing from reservoir into the trip tank. Typically, the combination of the blowout preventer (BOP) and the trip tank is aimed to control pressure escaping from the reservoir.

In a further embodiment, a fishing tool may be used to fish out the cut off RTP from the hole.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1 illustrates a block diagram of micro coil tubing unit (CTU) used in installing RTP.

FIG. 2 illustrates an injector head and injector block used in a micro CTU.

FIG. 3 is illustrates a stripper rubber that is part of a standard CTU equipment.

FIG. 4 illustrates blow out preventer (BOP) connected within the CTU.

FIG. 5 shows a rod clamp being used to hold on to RTP within the CTU.

FIG. 6 shows a reinforced thermoplastic pipe with layers.

FIG. 7 shows packer and assembly for holding RTP in place inside existing tubing.

### DETAILED DESCRIPTION

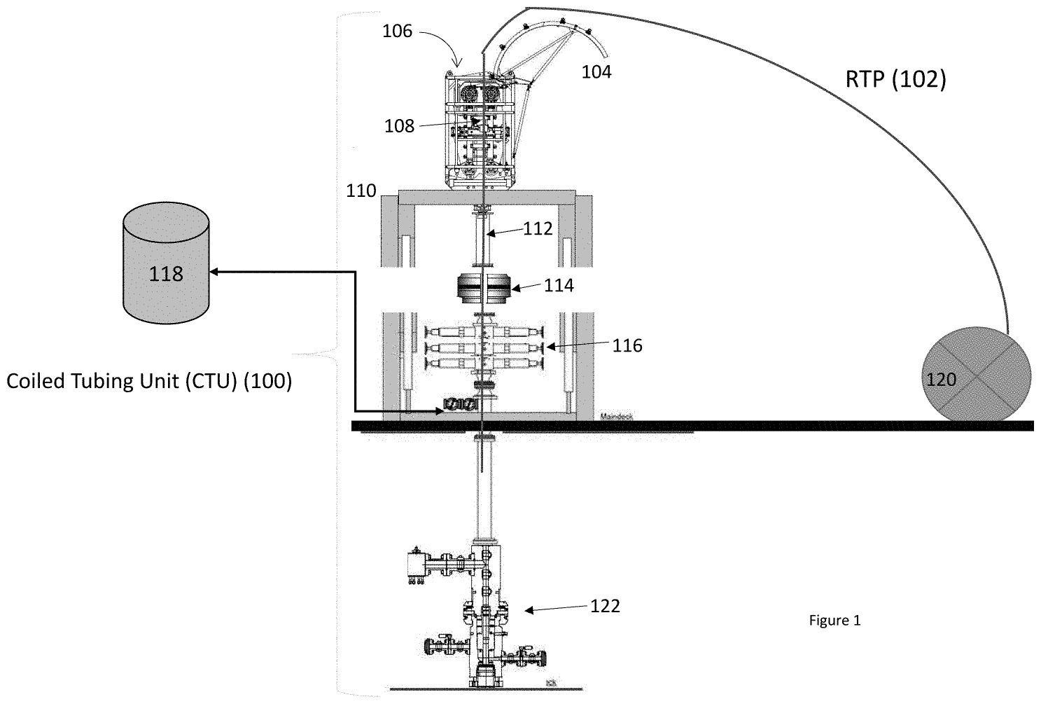

Referring to FIG. 1, there is illustrated an assembly for installing reinforced thermoplastic pipe (RTP) (102) into a production tube in hydrocarbon wells. The RTP (102) generally comprises of a plurality of layers which include an inner and outer layer of polymer and a mid-layer of fiber (as seen in FIG. 6) that provides the RTP (102) with structural strength. It is to be appreciated that the RTP (102) may comprise of more than 3 layers (not shown in FIG. 6). RTP (102) has high corrosion and temperature resistance, is less susceptible to scale and pressure drop compared to traditional steel pipes.

The installation is done using a micro coiled tubing unit (CTU) (100) to run RTP assembly (705) in existing shut in wells. The CTU (100) includes a gooseneck (104) on top of the CTU (100), which is to ensure that the RTP (102) does not kink and would bend correctly into the assembly.

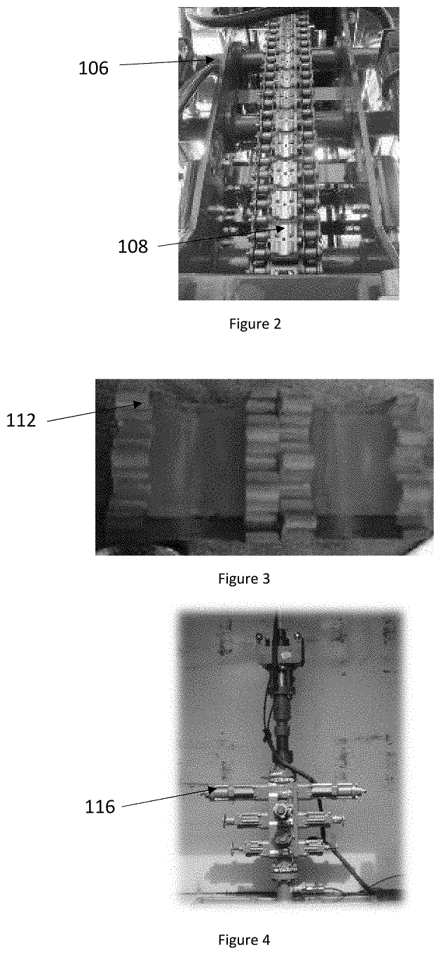

FIGS. 1 and 2 show an injector head (106) and an injector block (108) that is used to push and pull the RTP (102) along the length of the CTU (100). An injector frame (110) holds up the injector head (106) of the CTU (100). A rod clamp (114) is provided in order to hold the RTP (102) in place as seen in FIG. 1. This is due to the elasticity of RTP (102) that may cause the material to distort into elliptical shape. This distortion is not faced when using standard steel pipes as steel is not elastomeric as RTP (102). The rod clamp (114) is provided with a large surface area for gripping onto the RTP (102) to minimize damage to the RTP (102).

A blow out preventer (BOP) (116) as seen in FIG. 4 is used to provide isolation in case there is a pressure build-up which is released from the reservoir. A stripper rubber (112) is commonly used in a CTU to prevent pressure from building up in the first place. However, in the present invention, if the pressure levels build up too high, the excess pressure is caught by a trip tank (118), instead of a stripper rubber (112). FIG. 3 shows a stripper rubber (112) that is commonly used. The trip tank shows displacement of volume due to the pressure increase. The BOP (116), which is connected to the trip tank (118) as seen in FIG. 1 cuts of pressure by cutting off the RTP (102) at that point and isolates pressure from reservoir. A fishing tool may be used to fish out the cut off RTP from the hole. This combination of the BOP (116) and the trip tank (118) is aimed to control pressure escaping from the reservoir.

The BOP (116) is also usually used to hold on to weight of pipes during installation of steel pipes. However, the BOP (116) alone cannot be used to grip on to the RTP (102) due to the elastomeric nature of the RTP (102). The use of the rod clamp (112) as described earlier is used to distribute the force over a larger surface to minimize damage.

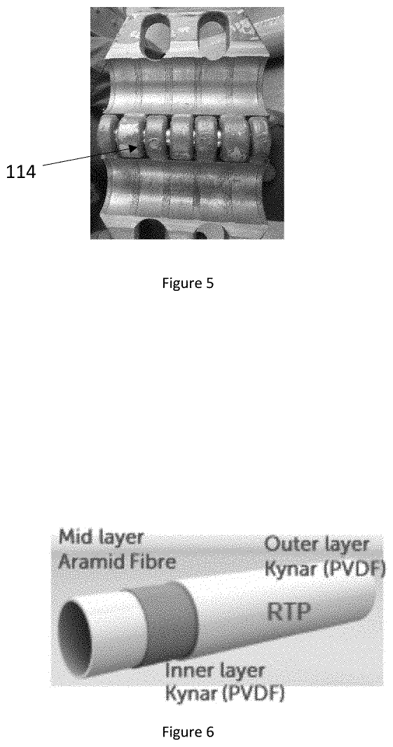

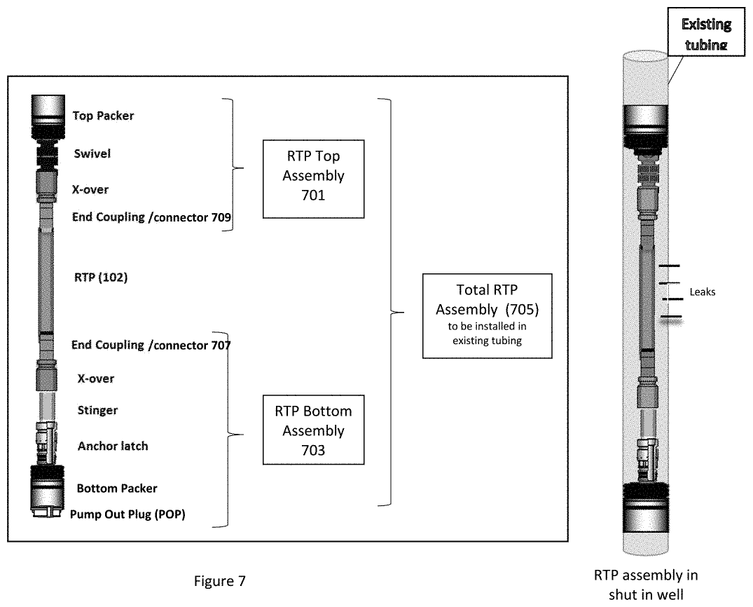

A method of installing a reinforced thermoplastic pipe (RTP) (102) is described herein using the CTU (100). The coiled tubing unit (CTU) (100) is rigged up above existing shut in wells at main deck. Before installing the RTP, pressure is injected into the RTP (102) to overcome any existing pressure from reservoir. RTP (102) is run from a spool (120) through a gooseneck (104) to ensure that the RTP does not kink and bends properly. FIG. 7 shows one end of a connector (707) swaged vertically on to one end of an RTP (102). The swaged end of the connector (707) is connected to the bottom assembly (703) where it is run along its length into the CTU (100) for a predetermined top packer setting depth. The RTP (102) that is run in is secured with a rod clamp (114), as seen in FIG. 5, and cut off above the rod clamp (114), where excess RTP is removed.

The RTP (102) is then swaged vertically to a connector (709) facing upwards and measured out to a predetermined length between a top packer setting length and a bottom packer setting length as seen in FIG. 7. FIG. 7 shows a top packer and bottom packer in the RTP assembly (705). The packer is used to hold RTP in place inside existing tubing after being detached from CTU (100) and to isolate leaks from being in contact with the RTP or flow area. Both ends of the RTP are then connected to a top assembly (701) and bottom assembly (703) respectively. A pull test can be conducted on the connectors (707, 709) to ensure fitting of the RTP is complete. The method as described above is different from that used for installing a standard steel pipe that is used commonly as the RTP is more elastomeric than steel. This requires the connectors with metal collars to be used to ensure a grip due to the elastomeric material of the RTP.

It is to be appreciated that swaging does not have to be done in steel pipe installations as steel pipes have threaded ends that can be coupled with other accessories. However, the coupling between elastomeric material such as RTP and steel requires a connector. In the preferred embodiment, a metal collar is placed over the ends of the RTP and swaged to fit the connectors on the RTP. Additionally, the collar also prevents fluid communication from outside the RTP and maintains a circular shape of RTP, instead of allowing the pressure to distort the diameter of the pipe into elliptical shape.

The method further includes the use of a trip tank (118) and a BOP (116) to ensure that pressure build-up is contained. The trip tank (118) further allows the displacement to be monitored. When pressure escapes from reservoir to the surface, this can be observed by displacement of water levels in trip tank. Pressure can be cut off by the BOP (116) when the pressure exceeds a threshold point.

1. A method of installing a reinforced thermoplastic pipe (RTP) (102) in a production tube, the method comprising the steps of:
preparing a bottom assembly (703) in a production well,
swaging connectors (707, 709) onto both ends of the RTP (102),
connecting respective ends of the RTP (102) with the connectors (707, 709) to top and bottom assemblies (701, 703),
characterized in that, the connectors (707, 709) further include metal collars that maintain shape of the RTP (102) and prevent pressure from escaping the RTP (102) and a blowout preventer (BOP) (116) is provided to cut off the RTP (102) when displacement is detected by a trip tank (118).

2. The method as claimed in claim 1, the method further includes securing the RTP (102) with a rod clamp (114) to minimize damage to the RTP (102) during swaging process and make up to assembly (705).

3. The method as claimed in claim 1, the method further includes displacing released liquids and/or gases overflowing from reservoir into the trip tank (118).

4. The method as claimed in claim 1, wherein the swaged end of the connector (707) is connected to the bottom assembly (703) into the CTU (100) for a predetermined top packer setting depth.

5. A coiled tubing unit (CTU) (100) for installing a reinforced thermoplastic pipe (RTP) (102) in a production tube, the unit (100) comprising:
an injector block (108) supported by an injector head (106), used to direct the RTP (102) with assembly (705) into the production tube,
characterized in that, both ends of the RTP (102) fit connectors (707, 709) with a metal collar, wherein the metal collar maintains shape of the RTP (102) and prevents pressure from escaping the RTP (102), and a trip tank (118) is further connected to the CTU (100) for displacing released liquids and/or gases overflowing from reservoir into the trip tank (118).

6. The CTU (100) as claimed in claim 5, wherein a rod clamp (114) is provided for securing the RTP (102) to minimize damage to the RTP (102) during swaging process and make up to assembly (705).

7. The CTU (100) as claimed in claim 5, wherein the trip tank (118) is further connected to the CTU (100) for displacing released liquids and/or gases overflowing from reservoir into the trip tank (118).

8. The CTU (100) as claimed in claim 5, wherein a blowout preventer (BOP) (116) is provided to cut off the RTP (102) when displacement is detected by the trip tank (118).
